(19) United States
(12) Patent Application Publication
(10) Pub. No.: US 2023/0104348 A1
(43) Pub. Date: Apr. 6, 2023

(54) ENERGY STORAGE DEVICE

(71) Applicant: GS Yuasa International Ltd., Kyoto-shi, Kyoto (JP)

(72) Inventors: Kenta OGI, Kyoto (JP); Takayuki KOYAMA, Kyoto (JP); Shota ITO, Kyoto (JP); Akihiko MIYAZAKI, Kyoto (JP)

(21) Appl. No.: 17/910,182

(22) PCT Filed: Mar. 8, 2021
(86) PCT No.: PCT/JP2021/009023

§ 371 Date: Sep. 8, 2022

(30) Foreign Application Priority Data
Mar. 11, 2020 (JP) 2020-042452

(51) Int. Cl. H01M 10/0583; H01M 4/133; H01M 4/587

(52) U.S. Cl. CPC H01M 10/0583; H01M 4/133; H01M 4/587; H01M 10/0525

(57) ABSTRACT

An aspect of the present invention is an energy storage device including: a negative electrode including a pair of flat portions facing each other and a curved folding portion connecting end portions on one side of the pair of flat portions to each other; and a sheet-like positive electrode disposed between the pair of flat portions of the negative electrode, in which the negative electrode includes a negative electrode substrate and a negative active material layer stacked on a surface of the negative electrode substrate directly or indirectly in a non-pressed or low-pressure pressed state, the negative active material layer contains a negative active material, the negative active material contains solid graphite particles, and the solid graphite particle has an aspect ratio of 1 or more and 5 or less.

### TECHNICAL FIELD

The present invention relates to an energy storage device.

### BACKGROUND ART

Nonaqueous electrolyte secondary batteries typified by lithium ion nonaqueous electrolyte secondary batteries are widely in use for electronic equipment such as personal computers and communication terminals, automobiles, and the like because the batteries have high energy density. The nonaqueous electrolyte secondary battery is generally provided with an electrode assembly with a pair of electrodes electrically isolated by a separator, and a nonaqueous electrolyte interposed between the electrodes and is configured to be charged and discharged by transferring ions between both the electrodes. Capacitors such as lithium ion capacitors and electric double-layer capacitors are also widely in use as energy storage devices except for the nonaqueous electrolyte secondary batteries.

One typical configuration of such an energy storage device includes an electrode (positive electrode and negative electrode) in which an electrode active material layer containing an electrode active material is held on an electrode substrate. As a negative active material of the energy storage device, a carbon material such as graphite is used (see Patent Document 1). On the other hand, a lithium ion secondary battery in which an electrode plate of a negative electrode or a positive electrode is alternately folded and stacked in a zigzag manner is conventionally known (see Patent Document 2). The electrode plate having the structure in which the electrode plate is stacked in a zigzag manner is less affected by misalignment between a negative electrode plate and a positive electrode plate, and is characterized by having a high short circuit suppressing effect because electrode chips are less likely to be generated as compared with a rectangular electrode plate.

### PRIOR ART DOCUMENTS

### Patent Documents

Patent Document 1: JP-A-2005-222933
Patent Document 2: JP-A-2014-103082

### SUMMARY OF THE INVENTION

### Problems to be Solved by the Invention

However, the inventors have confirmed that, in a case where the negative electrode is stacked in a state of having a curved folding structure, when graphite is further adopted as the negative active material, there are some events in which a negative active material layer falls off from a negative electrode substrate.

The present invention has been made in view of the above circumstances, and an object of the present invention is to provide an energy storage device in which falling of a negative active material layer is suppressed when a negative electrode has a curved folding structure.

### Means for Solving the Problems

An energy storage device according to an aspect of the present invention made for solving the problem mentioned above includes: a negative electrode including a pair of flat portions facing each other and a curved folding portion connecting end portions on one side of the pair of flat portions to each other; and a positive electrode disposed between the pair of flat portions of the negative electrode, in which the negative electrode includes a negative electrode substrate and a negative active material layer stacked on a surface of the negative electrode substrate directly or indirectly in a non-pressed or low-pressure pressed state, the negative active material layer contains a negative active material, the negative active material contains a solid graphite particle, and the solid graphite particle has an aspect ratio of 1 or more and 5 or less.

An energy storage device according to another aspect of the present invention includes: a negative electrode including a pair of flat portions facing each other and a curved folding portion connecting end portions on one side of the pair of flat portions; and a positive electrode disposed between the pair of flat portions of the negative electrode, in which the negative electrode includes a negative electrode substrate and a negative active material layer directly or indirectly stacked on a surface of the negative electrode substrate, the negative active material layer contains a negative active material, the negative active material contains a solid graphite particle, the solid graphite particle has an aspect ratio of 1 or more and 5 or less, and a ratio Q2/Q1 of a surface roughness Q2 of the negative electrode substrate in a region without the negative active material layer disposed to a surface roughness Q1 of the negative electrode substrate in a region with the negative active material layer disposed is 0.90 or more.

### Advantages of the Invention

According to the present invention, it is possible to provide an energy storage device in which falling of the negative active material layer is suppressed when the negative electrode has a curved folding structure.

### BRIEF DESCRIPTION OF THE DRAWINGS

FIG. 1 is a schematic exploded perspective view illustrating a configuration of an energy storage device of an embodiment of the present invention.

FIG. 2 is a schematic exploded perspective view of a positive electrode, a negative electrode, and a separator constituting an electrode assembly in FIG. 1.

FIG. 3 is a schematic cross-sectional view for explaining the electrode assembly.

FIG. 4 is a schematic cross-sectional view illustrating an electrode assembly in another embodiment of the present invention.

FIG. 5 is a schematic diagram illustrating an embodiment of an energy storage apparatus including a plurality of the energy storage devices.

### MODE FOR CARRYING OUT THE INVENTION

First, an outline of an energy storage device disclosed in the present specification will be described.

An energy storage device according to an aspect of the present invention includes: a negative electrode including a pair of flat portions facing each other and a curved folding portion connecting end portions on one side of the pair of flat portions to each other; and a positive electrode disposed between the pair of flat portions of the negative electrode, in which the negative electrode includes a negative electrode substrate and a negative active material layer stacked on a surface of the negative electrode substrate directly or indirectly in a non-pressed or low-pressure pressed state, the negative active material layer contains a negative active material, the negative active material contains a solid graphite particle, and the solid graphite particle has an aspect ratio of 1 or more and 5 or less.

In the energy storage device, falling of the negative active material layer is suppressed when the negative electrode has a curved folding structure. The reason for this is unknown but is considered as follows. When the energy storage device includes the negative electrode including the pair of flat portions facing each other and the curved folding portion connecting the end portions on one side of the pair of flat portions to each other and the positive electrode disposed between the pair of flat portions of the negative electrode, the negative active material of the curved folding portion does not face the positive electrode, so that contribution to a charge-discharge reaction is small. Thus, in the case of containing a negative active material having a large volume change associated with charge-discharge such as graphite, an expansion rate of the negative active material layer due to insertion of lithium ions into the negative active material during charging is different between the flat portion facing the positive electrode and the curved folding portion not facing the positive electrode. Specifically, the negative active material layer of the flat portion facing the positive electrode is likely to expand, and the negative active material layer of the curved folding portion not facing the positive electrode is less likely to expand. Thus, stress is applied to an interface between the curved folding portion and the flat portion, and the negative active material layer of the folding portion to which particularly large stress is likely to be applied tends to fall off from the negative electrode substrate. On the other hand, the energy storage device includes the negative electrode in which the negative active material layer containing solid graphite particles is disposed in the non-pressed or low-pressure pressed state, and has a configuration in which stress is hardly applied to the negative active material until the electrode assembly is formed. Thus, the graphite particles themselves have little residual stress, so that it is possible to suppress uneven expansion of the negative active material layer due to release of the residual stress. Since the graphite particles contained in the negative active material are solid, the density in the graphite particles is uniform, and the graphite particles are nearly spherical due to having an aspect ratio of 1 to 5, so that current concentration is less likely to occur, and uneven expansion of the negative active material layer can thus be prevented. Further, since the shape is close to a spherical shape, adjacent graphite particles are hardly caught by each other, and the graphite particles are moderately slid over each other, so that even if the graphite particles expand, they are easily maintained in a state close to closest packing. Thus, in the energy storage device, even if the graphite particles expand, the particles expand relatively uniformly and moderately slide over each other, so that a negative active material layer having a high packing ratio of the graphite particles is maintained, and as a result, the expansion of the negative active material layer which occurs at initial charge can be suppressed. Thus, it is presumed that the stress applied to the interface between the curved folding portion and the flat portion of the negative electrode is reduced, and the falling off of the negative active material at the folding portion is suppressed.

The term “non-pressed” means that a step of applying pressure (linear pressure) to the negative active material layer is not performed during manufacture. The term “low-pressure pressed” means that a step of applying a pressure (linear pressure) of less than 10 kgf/mm to the negative active material layer by an apparatus intended for applying a pressure to a workpiece, such as a roll press, is carried out during manufacture. The “aspect ratio” means the A/B value that is the ratio of the longest diameter A of the particle to the longest diameter B in the direction perpendicular to the diameter A in the cross section of the particle observed in the SEM image by the scanning electron microscope.

An energy storage device according to one aspect of the present invention includes: a negative electrode including a pair of flat portions facing each other and a curved folding portion connecting end portions on one side of the pair of flat portions to each other; and a positive electrode disposed between the pair of flat portions of the negative electrode, in which the negative electrode includes a negative electrode substrate and a negative active material layer directly or indirectly stacked on a surface of the negative electrode substrate, the negative active material layer contains a negative active material, the negative active material contains a solid graphite particle, the solid graphite particle has an aspect ratio of 1 or more and 5 or less, and a ratio Q2/Q1 of a surface roughness Q2 of the negative electrode substrate in a region without the negative active material layer disposed to a surface roughness Q1 of the negative electrode substrate in a region with the negative active material layer disposed is 0.90 or more.

In the negative electrode in which the negative active material layer is stacked on the negative electrode substrate, as a strong pressure is applied to the negative active material layer, the surface roughness of a region of the negative electrode substrate in which the negative active material layer is formed becomes rougher, and thus the Q2/Q1 becomes smaller. In other words, in the negative electrode substrate, in a state where no pressure is applied to the negative active material layer, the surface roughness is almost the same value in the region with the negative active material layer disposed and the region without the negative active material layer disposed (for example, an exposed region of the negative electrode substrate in a case where the negative electrode has an exposed part of the negative electrode substrate). That is, the Q2/Q1 becomes close to 1. In the energy storage device, the Q2/Q1 is 0.90 or more, and there is no or little pressure applied to the negative active material layer. Thus, the graphite particles themselves have little residual stress, so that it is possible to suppress uneven expansion of the negative active material layer due to release of the residual stress. Since the graphite particles contained in the negative active material are solid, the density in the graphite particles is uniform, and the graphite particles are nearly spherical due to having an aspect ratio of 1 to 5, so that current concentration is less likely to occur, and uneven expansion of the negative active material layer can thus be prevented. Further, since the shape is close to a spherical shape, adjacent graphite particles are hardly caught by each other, and the graphite particles are moderately slid over each other, so that even if the graphite particles expand, they are easily maintained in a state close to closest packing. Thus, in the energy storage device, even if the graphite particles expand, the particles expand relatively uniformly and moderately slide over each other, so that a negative active material layer having a high packing ratio of the graphite particles is maintained, and as a result, the expansion of the negative active material layer which occurs at initial charge can be suppressed. Thus, it is presumed that the stress applied to the interface between the curved folding portion and the flat portion of the negative electrode is eliminated and reduced, and the falling off of a negative composite at the folding portion is suppressed.

The negative electrode is preferably a belt-like body folded in a bellows shape along a longitudinal direction. When the negative electrode is the belt-like body folded in a bellows shape along the longitudinal direction, a plurality of the folding portions to which particularly large stress is likely to be applied are provided. In the energy storage device, since the graphite particles contained in the negative active material are solid, the density in the graphite particles is uniform, and the graphite particles are nearly spherical due to having an aspect ratio of 1 to 5, so that current concentration is less likely to occur, and uneven expansion of the negative active material layer can thus be prevented. Therefore, in the energy storage device which is the belt-like body in which the negative electrode is folded in a bellows shape along the longitudinal direction, the application effect of this configuration can be more suitably exhibited. Here, the term “bellows shape” refers to a repeating structure of mountain folds and valley folds. The curved shape of the folding portion includes not only a curved shape in which an arc is formed but also a bent shape.

Hereinafter, an energy storage device according to an embodiment of the present invention will be described in detail. The names of the respective constituent members (respective constituent elements) used in the respective embodiments may be different from the names of the respective constituent members (respective constituent elements) used in the background art.

### <Energy Storage Device>

### First Embodiment

An energy storage device according to an embodiment of the present invention includes an electrode assembly, a nonaqueous electrolyte, and a case for housing the electrode assembly and the nonaqueous electrolyte. The electrode assembly has a negative electrode and a positive electrode. The nonaqueous electrolyte is interposed between the positive electrode and the negative electrode in a state where the separator is impregnated with the nonaqueous electrolyte.

### [Specific Configuration of Energy Storage Device]

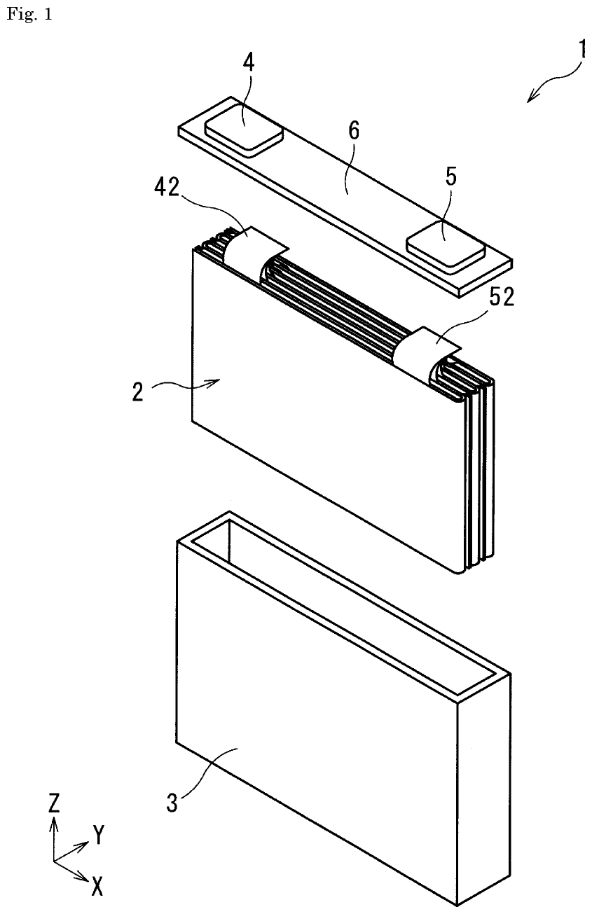

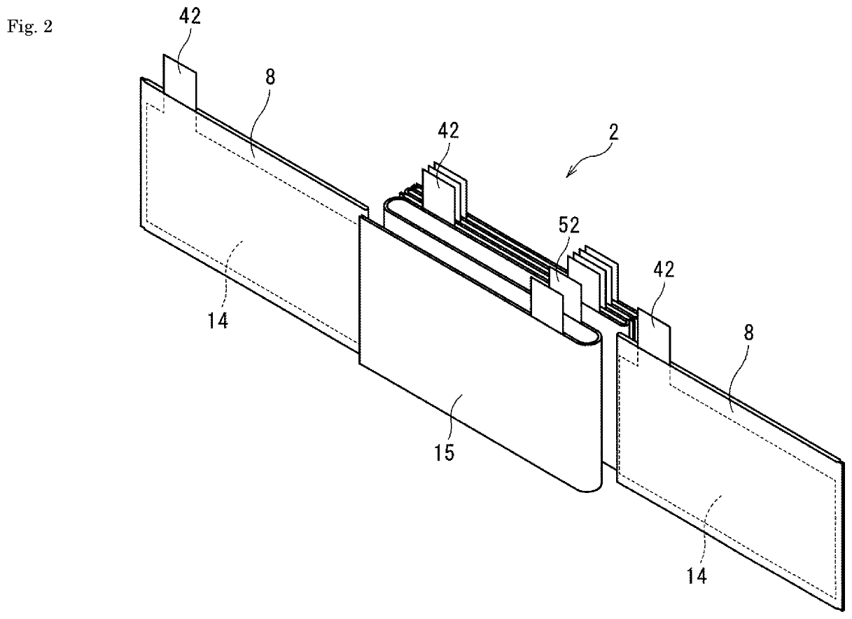

Next, a nonaqueous electrolyte secondary battery will be described as a specific configuration example of the energy storage device according to an embodiment of the present invention. FIG. 1 is a schematic exploded perspective view illustrating a configuration of the energy storage device according to an embodiment of the present invention. FIG. 2 is a schematic exploded perspective view of the positive electrode, the negative electrode, and the separator constituting the electrode assembly of FIG. 1. As illustrated in FIG. 1, an energy storage device 1 includes a flat rectangular parallelepiped case 3 having an opening, an elongated rectangular plate-like lid body 6 capable of closing the elongated rectangular opening of the case 3, an electrode assembly 2 housed in the case 3, and a positive electrode terminal 4 and a negative electrode terminal 5 provided on the lid body 6. The case 3 houses the nonaqueous electrolyte together with the electrode assembly 2 in an internal space.

An upper surface of the case 3 is covered with the lid body 6. The case 3 and the lid body 6 are made of a metal plate. As the material of the metal plate, for example, aluminum can be used. The lid body 6 is provided with a positive electrode terminal 4 and a negative electrode terminal 5 that conduct electricity to the outside. Further, when the energy storage device 1 is a nonaqueous electrolyte energy storage device, a nonaqueous electrolyte (electrolyte solution) is injected into the case 3 through an injection hole (not illustrated) provided in the lid body 6.

The positive electrode terminal 4 is an electrode terminal electrically connected to the positive electrode 14 of the electrode assembly 2 illustrated in FIG. 2, and the negative electrode terminal 5 is an electrode terminal electrically connected to the negative electrode 15 of the electrode assembly 2. That is, the positive electrode terminal 4 and the negative electrode terminal 5 are metal-made electrode terminals through which electricity stored in the electrode assembly 2 is discharged to a space outside the energy storage device 1, and through which electricity is introduced into a space inside the energy storage device 1 for storing electricity in the electrode assembly 2. In the present embodiment, a thickness direction (stacking direction) of the electrode assembly 2 is defined as a Y-axis direction, and a long-axis direction in a cross section perpendicular to the Y-axis of the electrode assembly 2 is defined as an X-axis direction. The direction perpendicular to the Y-axis and the X-axis is defined as a Z-axis direction.

As illustrated in FIG. 2, the electrode assembly 2 is formed by disposing a separator 8 between the positive electrodes 14 and the negative electrodes 15 which are alternately stacked. Specifically, the electrode assembly 2 is formed by repeatedly stacking the negative electrode 15, the separator 8, the positive electrode 14, and the separator 8 in this order.

The nonaqueous electrolyte is interposed between the positive electrode 14 and the negative electrode 15 in a state where the separator 8 is impregnated with the nonaqueous electrolyte. In FIG. 2, in order to illustrate the positive electrode 14 and the negative electrode 15, the positive electrode 14 disposed inside the two separators 8 disposed on the front side (minus side in the Y axis direction) is indicated by a broken line. In order to prevent the positive electrode 14 and the negative electrode 15 from being short-circuited to each other, the separator 8 is stacked so as to have a larger area than the positive electrode 14 and the negative electrode 15 when viewed from the stacking direction, and to have each end side disposed outside end sides (provided that, excluding a positive electrode tab 42 and a negative electrode tab 52) of the positive electrode 14 and the negative electrode 15.

The positive electrode tab 42 is formed in the positive electrode 14 so as to protrude toward a plus side (upward) in the Z-axis direction of the positive electrode 14. The negative electrode tab 52 is formed in the negative electrode 15 so as to protrude toward a plus side (upward) in the Z-axis direction of the negative electrode 15. The positive electrode tab 42 and the negative electrode tab 52 protrude upward from an end portion (upper end) on the plus side in the Z axis direction of the separator 8. In the positive electrode tab 42, the positive active material layer is not formed, and the positive electrode substrate is exposed. In the negative electrode tab 52, the negative active material layer is not formed, and the negative electrode substrate is exposed.

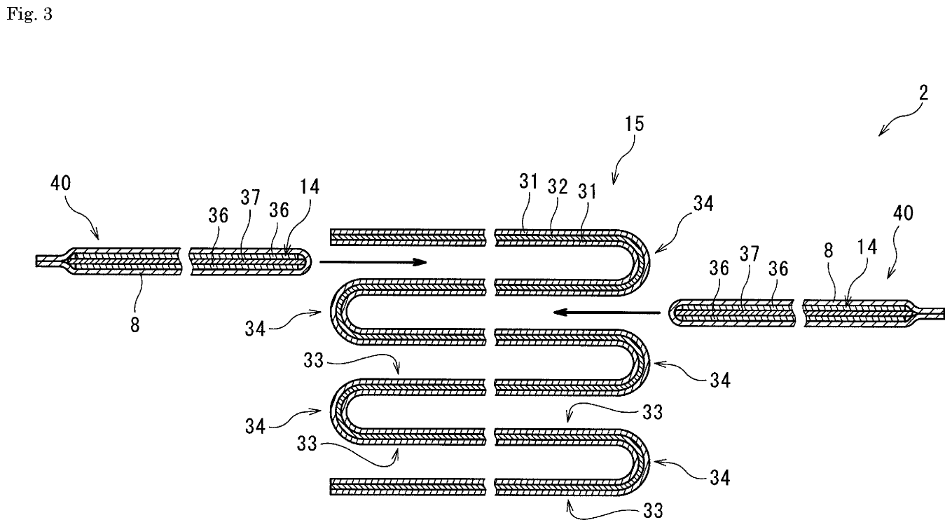

FIG. 3 is a schematic cross-sectional view for explaining the electrode assembly. As illustrated in FIG. 3, the negative electrode 15 has a negative electrode substrate 32 and a negative active material layer 31 overlaid on each of both surfaces of the negative electrode substrate 32. That is, the negative electrode 15 includes one negative electrode substrate 32 and a pair of the negative active material layers 31 on both sides of the negative electrode substrate 32. The negative electrode 15 has an elongated sheet shape and has a curved folding portion 34. Specifically, the negative electrode 15 is a belt-like body folded in a bellows shape along the longitudinal direction. The negative electrode 15 has a pair of flat portions 33 facing each other and the curved folding portion 34 connecting end portions on one side of the pair of flat portions 33 to each other. The positive electrode 14 is disposed between the curved folding portions 34. The sheet-like (plate-like) positive electrode 14 is disposed so as to alternately face the flat portion 33 of the negative electrode 15. As illustrated in FIG. 1, the electrode assembly 2 is housed in the case 3 such that each of the flat portions 33 of the negative electrode 15 is parallel (substantially parallel) to the longitudinal direction (long side wall) of the case 3 (that is, each of the folding portions 34 faces a short side wall).

The electrode assembly 2 includes the negative electrode 15 and a positive electrode member 40 including the positive electrode 14 and the separator 8. In the electrode assembly 2 of the present embodiment, the positive electrode 14 and the separator 8 in a state of sandwiching the positive electrode 14 constitute the positive electrode member 40. The separator 8 is a sheet-like insulating member, and is disposed between the negative electrode 15 and the positive electrode 14. Accordingly, in the electrode assembly 2, the negative electrode 15 and the positive electrode 14 are insulated from each other. The separator 8 holds the nonaqueous electrolyte in the case 3. With such a configuration, at the time of charge-discharge of the energy storage device 1, charged ions can move between the negative electrode 15 and the positive electrode 14 facing each other with the separator 8 interposed therebetween. The separator 8 of the present embodiment covers the entire positive electrode 14 so as to sandwich the positive electrode 14. Specifically, the separator 8 is folded back at a central portion in the longitudinal direction so as to sandwich the positive electrode 14, and both end edges in a fold line direction are joined by adhesion, welding, or the like. At this time, the separator 8 is joined such that the rectangular positive electrode tab 42 protrudes from the folded-back separator 8. The shape of the separator of the energy storage device is not limited to the separator 8 in the present embodiment.

As illustrated in FIG. 3, the positive electrode 14 includes a positive electrode substrate 37 and a pair of positive active material layers 36 on both sides of the positive electrode substrate 37. On the other hand, the positive electrode tab 42 does not have the positive active material layer 36, and the positive electrode substrate 37 is exposed. The positive electrode 14 is disposed inside the curved folding portion 34 of the negative electrode 15 which is a belt-like body folded in a bellows shape along the longitudinal direction. Specifically, the positive electrode 14 is disposed between the adjacent flat portions 33 of the negative electrode 15. Thus, the electrode assembly 2 of the present embodiment has the plurality of positive electrodes 14. The positive active material layer 36 of the positive electrode 14 faces the negative active material layer 31 of the flat portion 33 of the negative electrode 15.

Returning to FIG. 1, a positive current collector (not illustrated) is disposed on the positive electrode terminal 4 side above the electrode assembly 2. The positive electrode tabs 42 extending from the respective positive electrodes 14 are bundled and electrically connected to the positive electrode terminal 4 via the positive current collector. A negative current collector (not illustrated) is disposed on the negative electrode terminal 5 side above the electrode assembly 2. The negative electrode tabs 52 extending from the flat portions of the negative electrode 15 are bundled and electrically connected to the negative electrode terminal 5 via the negative current collector.

### [Negative Electrode]

The negative electrode includes a negative substrate and a negative active material layer stacked directly or indirectly on at least one surface of the negative substrate. The negative active material layer of the first embodiment of the present invention is disposed in the non-pressed or low-pressure pressed state.

### (Negative Electrode Substrate)

The negative electrode substrate exhibits conductivity. As the material of the negative electrode substrate, a metal such as copper, nickel, stainless steel or a nickel-plated steel, or an alloy thereof is used. Among these, copper or a copper alloy is preferable. Examples of the negative electrode substrate include a foil and a vapor deposited film, and a foil is preferable from the viewpoint of cost. Therefore, the negative electrode substrate is preferably a copper foil or a copper alloy foil. Examples of the copper foil include a rolled copper foil and an electrolytic copper foil. To exhibit “conductivity” means that the volume resistivity measured in conformity with JIS-110505 (1975) is 1×10⁷ Ω·cm or less, and to be “non-conductive” means that the volume resistivity is more than 1×10⁷ Ω·cm.

The average thickness of the negative electrode substrate is preferably 2 μm or more and 35 μm or less, more preferably 3 μm or more and 30 μm or less, still more preferably 4 μm or more and 25 μm or less, and particularly preferably 5 μm or more and 20 μm or less. When the average thickness of the negative substrate falls within the above-described range, it is possible to increase the energy density per volume of the energy storage device while increasing the strength of the negative substrate. The “average thickness of the substrate” refers to a value obtained by dividing a cutout mass in cutout of a substrate having a predetermined area by a true density and a cutout area of the substrate.

### (Negative Active Material Layer)

The negative active material layer is disposed along at least one surface of the negative electrode substrate directly or with an intermediate layer interposed therebetween. The negative active material layer is formed of a so-called negative composite containing a negative active material.

In the energy storage device according to the first embodiment of the present invention, the negative active material contains solid graphite particles. When the negative active material contains the solid graphite particles, the expansion of the negative active material layer which occurs at initial charge can be suppressed. In addition, the negative active material may contain other negative active materials except for the solid graphite particles.

### (Solid Graphite Particles)

The term “solid” means that the inside of the particle is filled substantially without voids. More specifically, being “solid” means that in a cross section of a particle observed in a SEM image acquired by a scanning electron microscope (SEM), the area ratio excluding voids in the particle relative to the total area of the particle is 95% or more. In one preferred aspect, the area ratio of the solid graphite particles can be 97% or more (for example, 99% or more). The “graphite” is a carbon substance in which the average grid spacing d(002) of a (002) plane, measured by an X-ray diffraction method before charge-discharge or in a discharged state, is less than 0.34 nm. The “discharged state” herein refers to a state where an open circuit voltage is 0.7 V or more in a unipolar battery using a negative electrode, containing a carbon material as a negative active material, as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/reduction potential of Li. That is, the fact that the open circuit voltage in the unipolar battery is 0.7 V or more means that lithium ions that can be occluded and released in association with charge-discharge are sufficiently released from the carbon material that is the negative active material.

The area ratio T of the graphite particle excluding voids in the particle relative to the total area of the particle can be determined in accordance with the following procedure.

### (1) Preparation of Sample for Measurement

The powder of the graphite particles to be measured is fixed with a thermosetting resin. A cross-section polisher is used to expose the cross section of the graphite particles fixed with resin to produce a sample for measurement.

### (2) Acquisition of SEM Image

For acquiring the SEM image, JSM-7001F (manufactured by JEOL Ltd.) is used as a scanning electron microscope. As the SEM image, a secondary electron image is observed. The acceleration voltage is 15 kV. The observation magnification is set such that the number of graphite particles appearing in one field of view is 3 or more and 15 or less. The obtained SEM image is stored as an image file. In addition, various conditions such as spot diameter, working distance, irradiation current, luminance, and focus are appropriately set so as to make the contour of the graphite particle clear.

### (3) Cut-Out of Contour of Graphite Particle

The contour of the graphite particle is cut out from the acquired SEM image by using an image cutting function of an image editing software Adobe Photoshop Elements 11. The contour is cut out by using a quick selection tool to select the outside of the contour of the active material particle and edit a portion except for the graphite particle to a black background. At this time, when the number of the graphite particles from which the contours have been able to be cut out is less than three, the SEM image is acquired again, and the cutout is performed until the number of the graphite particles from which the contours have been able to be cut out becomes three or more.

### (4) Binarization Processing

The image of the first graphite particle among the cut-out graphite particles is binarized by using image analysis software PopImaging 6.00 to set to a threshold value a concentration 20% lower than a concentration at which the intensity becomes maximum. By the binarization processing, an area on the low-concentration side is calculated to obtain “an area S1 excluding voids in the particle”.

Next, the image of the first graphite particle is binarized using a concentration 10 as a threshold value. The outer edge of the graphite particle is determined by the binarization processing, and the area inside the outer edge is calculated to obtain an “area S0 of the whole particle”.

By calculating a ratio of S1 relative to S0 (S1/S0) by using S1 and S0 calculated above, “an area ratio T1 excluding voids in the particle relative to the total area of the particle” in the first graphite particle is calculated.

The images of the second and subsequent graphite particles among the cut-out graphite particles are also subjected to the binarization processing described above, and the areas S1 and S0 are calculated. Based on the calculated area S1 and area S0, area ratios T2, T3, . . . of the respective graphite particles are calculated.

### (5) Determination of Area Ratio T

By calculating the average value of all the area ratios T1, T2, T3, . . . calculated by the binarization processing, “the area ratio T of the graphite particle excluding voids in the particle relative to the total area of the particle” is determined.

The solid graphite particle can be used by appropriately selecting from various known graphite particles. Examples of the known graphite particles include natural graphite particles and artificial graphite particles. Here, the natural graphite is a generic term for graphite which can be taken from natural minerals, and the artificial graphite is a generic term for artificially produced graphite. Specific examples of the natural graphite particles include particles of scale-like graphite, massive graphite (flake graphite), and earthy graphite. The solid graphite particles may be flat natural graphite particles having a scale-like shape or spheroidized natural graphite particles obtained by spheroidizing the scale-like graphite. As the solid graphite particles, natural graphite particles may be used, or artificial graphite particles may be used; however, since artificial graphite generally has a smaller specific surface area than the natural graphite particles, the artificial graphite particles are more preferable from the viewpoint of durability such that film formation associated with a charge-discharge reaction is suppressed. In addition, the artificial graphite particle may be a graphite particle, the surface of which is coated (for example, with amorphous carbon coating).

The R value of the solid graphite particles can be generally 0.25 or more (for example, 0.25 or more and 0.8 or less), and is, for example, 0.28 or more (for example, 0.28 or more and 0.7 or less), typically 0.3 or more (for example, 0.3 or more and 0.6 or less). In some aspects, the R value of the solid graphite particles may be 0.5 or less, or 0.4 or less. The “R value” herein is the ratio of the peak intensity (I_{D1}) of the D band to the peak intensity (I_{G1}) of the G band (I_{D1}/I_{G1}) in the Raman spectrum.

Here, the “Raman spectrum” is obtained by performing Raman spectrometry under the conditions of a wavelength of 532 nm (YAG laser), a grating of 600 g/mm, and a measurement magnification of 100 times using “HRRevolution” manufactured by HORIBA, Ltd. Specifically, first, Raman spectrometry is performed over the range of 200 cm⁻¹ to 4000 cm⁻¹, and the obtained data is normalized by the maximum intensity (for example, the intensity of the G band) in the measurement range with the minimum value at 4000 cm⁻¹ as a base intensity. Next, using a Lorentz function, fitting is performed on the obtained curve to calculate the intensities of the G band near 1580 cm⁻¹ and the D band near 1350 cm⁻¹, which are defined as “peak intensity of G band (I_{G1})” and “peak intensity of D band (I_{D1})”, respectively, in the Raman spectrum.

The lower limit of the aspect ratio of the solid graphite particles is 1 (for example, 1.5), preferably 2.0. In some aspects, the aspect ratio of the solid graphite particle may be 2.2 or more (for example, 2.5 or more, e.g. 2.7 or more). On the other hand, the upper limit of the aspect ratio of the solid graphite particles is 5 (for example, 4.5) and is preferably 4.0. In some aspects, the aspect ratio of the solid graphite particle may be 3.5 or less (for example, 3.0 or less). By setting the aspect ratio of the solid graphite particles within the above range, the graphite particles are close to spherical shape, and current concentration is less likely to be caused, thus allowing the negative active material layer to be prevented from being unevenly expanded.

The aspect ratio can be determined as follows.

### (1) Preparation of Sample for Measurement

A sample for measurement having an exposed cross section used for determining the area ratio T described above is used.

### (2) Acquisition of SEM Image

For acquiring the SEM image, JSM-7001F (manufactured by JEOL Ltd.) is used as a scanning electron microscope. As the SEM image, a secondary electron image is observed. The acceleration voltage is 15 kV. The observation magnification is set so that the number of negative active material particles appearing in one field of view is 100 or more and 1000 or less. The obtained SEM image is stored as an image file. In addition, various conditions such as spot diameter, working distance, irradiation current, luminance, and focus are appropriately set so as to make the contour of the negative active material particle clear.

### (3) Determination of Aspect Ratio

From the acquired SEM image, hundred negative active material particles are randomly selected, and for each of the particles, the longest diameter A of the negative active material particle and the longest diameter B in the direction perpendicular to the diameter A are measured to calculate the A/B value. The average value of all the calculated A/B values is calculated to determine the aspect ratio of the negative active material particles.

The lower limit of an average particle size of the solid graphite particles is preferably 1 μm, and more preferably 2 μm. The upper limit of the average particle size is normally 10 μm (for example, 8 μm). The upper limit of the average particle size is preferably 5 μm, and more preferably 4.5 μm. In some aspects, a median diameter of the solid graphite particles may be 4 μm or less, or 3.5 μm or less (for example, 3 μm or less). The technique disclosed herein can be preferably carried out in an aspect in which the average particle size of the solid graphite particles is 1 μm or more and less than 5 μm (or 1.5 μm or more and 4.5 μm or less, particularly 2 μm or more and 4 μm or less). When the average particle size of the solid graphite particles is in the above range, ease of handling during manufacture and the like can be enhanced.

The median diameter (D50) for “average particle size” mentioned above can be specifically the value measured by the following method. A laser diffraction type particle size distribution measuring apparatus (“SALD-2200” manufactured by Shimadzu Corporation) is used as a measuring apparatus, and Wing SALD-2200 is used as measurement control software. A scattering measurement mode is adopted, and a wet cell, in which a dispersion liquid with a measurement sample dispersed in a dispersion solvent circulates, is irradiated with a laser beam to obtain a scattered light distribution from the measurement sample. The scattered light distribution is approximated by a log-normal distribution, and a particle size corresponding to an accumulation degree of 50% is defined as a median diameter (D50). Preferred examples of the solid graphite particle disclosed herein include: one with a median diameter (D50) of 5 μm or less and an aspect ratio of 1 or more and 5 or less; one with a median diameter (D50) of 4.5 μm or less and an aspect ratio of 1.5 or more and 4.5 or less; one with a median diameter (D50) of 4 μm or less and an aspect ratio of 1.8 or more and 4 or less; and one with a median diameter (D50) of 3 μm or less and an aspect ratio of 2 or more and 3.5 or less. By using such a solid graphite particle with an aspect ratio and a median diameter (D50) within a predetermined range, the above-described effect can be more effectively exhibited.

The true density of the solid graphite particle is preferably 2.1 g/cm³ or more. By using the solid graphite particle having such a high true density, the energy density can be increased. Meanwhile, the upper limit of the true density of the solid graphite particles is, for example, 2.5 g/cm³. The true density is measured by a gas volume method with a pycnometer that uses a helium gas. The BET specific surface area of the solid graphite particle is not particularly limited, but is, for example, 3 m²/g or more. By using the solid graphite particle with a large BET specific surface area as described above, the above-described effect can be more effectively exhibited. The BET specific surface area of the solid graphite particle is preferably 3.2 m²/g or more, more preferably 3.5 m²/g or more, still more preferably 3.7 m²/g or more. The upper limit of the BET specific surface area of the solid graphite particle is, for example, 10 m²/g. The BET specific surface area of the solid graphite particle is preferably 8 m²/g or less, more preferably 6 m²/g or less, still more preferably 5 m²/g or less. The BET specific surface area of the solid graphite particle is grasped by pore size distribution measurement by one-point method using nitrogen gas adsorption.

The solid graphite particle may be, for example, spherical or non-spherical. Specific examples of the non-spherical shape include a massive shape, a spindle shape, a scale-like shape, a plate shape, an elliptical type, and an ovoid shape. Among them, a massive solid graphite particle is preferable. The solid graphite particle may have irregularities on the surface. The solid graphite particle may include a particle in which a plurality of graphite particles is aggregated.

The lower limit of the content of the solid graphite particles relative to the total mass of the negative active material is preferably 60 mass % and more preferably 70 mass %. In some aspects, the content of the solid graphite particles with respect to the total mass of the negative active material may be, for example, 75% by mass or more, or may be 80% by mass. By setting the content of the solid graphite particles to the above lower limit or more, charge-discharge efficiency can be further increased. On the other hand, the upper limit of the content of the solid graphite particles relative to the total mass of the negative active material may be, for example, 100 mass %.

### (Other Negative Active Materials)

The negative active material layer disclosed herein may contain other negative active materials other than the solid graphite particles mentioned above as long as the effect of the present invention is not impaired. Examples of the other negative active material include carbonaceous active materials such as hollow graphite particles and non-graphitized carbonaceous active materials, and non-carbonaceous active materials.

Examples of the non-graphitized carbonaceous active material include hardly graphitizable carbon and easily graphitizable carbon. The term “hardly graphitizable carbon” herein refers to a carbon material in which the average grid distance of the (002) plane d(002) determined by the X-ray diffraction method before charge-discharge or in the discharged state is 0.36 nm or more and 0.42 nm or less. The term “easily graphitizable carbon” refers to a carbon material in which the d(002) is 0.34 nm or more and less than 0.36 nm. In the case of containing the non-graphitized carbonaceous active material, the mass of the solid graphite particles is normally 70% by mass or more, preferably 80% by mass or more, more preferably 90% by mass or more, of the total mass of the carbonaceous active material contained in the negative active material layer. In particular, an energy storage device is preferable in which the solid graphite particles constitute 100% by mass of the carbonaceous active material contained in the negative active material layer.

Examples of the non-carbonaceous active material include semimetals such as Si, metals such as Sn, oxides of these metals, or composites of any of these metals and carbon materials. The content of the non-carbonaceous active material is normally, for example, 30% by mass or less, preferably 20% by mass or less, more preferably 10% by mass or less, of the total mass of the negative active material contained in the negative active material layer. The technique disclosed herein can be preferably carried out in an aspect in which the total ratio of the carbonaceous active material to the total mass of the negative active material contained in the negative active material layer is more than 90% by mass. The ratio of the carbonaceous active material is more preferably 95% by mass or more, still more preferably 98% by mass or more, particularly preferably 99% by mass or more. In particular, an energy storage device is preferable in which the carbonaceous active material constitutes 100% by mass of the negative active material contained in the negative active material layer.

The content of the negative active material in the negative active material layer is not particularly limited, but the lower limit thereof is preferably 50% by mass, more preferably 80% by mass, still more preferably 90% by mass. Meanwhile, the upper limit of the content is preferably 99% by mass, and more preferably 98 mass.

### (Other Optional Components)

The negative active material layer disclosed herein contains optional components such as a conductive agent, a binder (binding agent), a thickener, a filler and the like if necessary.

The solid graphite particles also have conductivity, and examples of the conductive agent include carbonaceous materials, metals, and conductive ceramics. Examples of the carbonaceous materials include graphitized carbon, non-graphitized carbon, and graphene-based carbon. Examples of the non-graphitized carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the shape of the conductive agent include a powdery shape and a fibrous shape. As the conductive agent, one of these materials may be used singly, or two or more thereof may be mixed and used. These materials may be composited and used. For example, a material obtained by compositing carbon black with CNT may be used. Among these materials, carbon black is preferable from the viewpoint of electron conductivity and coatability, and in particular, acetylene black is preferable.

When a conductive agent is used in the negative active material layer, the ratio of the conductive agent to the entire negative active material layer can be about 8.0% by mass or less, and is preferably typically about 5.0% by mass or less (for example, 1.0% by mass or less).

Examples of the binder include: thermoplastic resins such as fluororesin (polytetrafluoroethylene (PTFE), polyvinylidene fluoride (PVDF), etc.), polyethylene, polypropylene, polyacryl, and polyimide; elastomers such as ethylene-propylene-diene rubber (EPDM), sulfonated EPDM, styrene-butadiene rubber (SBR), and fluororubber; and polysaccharide polymers.

The content of the binder in the negative active material layer is preferably 1% by mass or more and 10% by mass or less, more preferably 3% by mass or more and 9% by mass or less. When the content of the binder is within the above-described range, the negative active material particles can be stably held.

Examples of the thickener include polysaccharide polymers such as carboxymethylcellulose (CMC) and methylcellulose. When the thickener has a functional group that is reactive with lithium and the like, the functional group may be deactivated by methylation or the like in advance.

The filler is not particularly limited. Examples of the main component of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals such as calcium fluoride, barium fluoride, and barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof.

When a filler is used in the negative active material layer, the ratio of the filler to the entire negative active material layer can be about 8.0% by mass or less, and is preferably typically about 5.0% by mass or less (for example, 1.0% by mass or less). In the present specification, the “main component” refers to a component having the highest content, for example, a component containing 50% by mass or more relative to the total mass.

The lower limit of the density of the negative active material layer is preferably 1.20 g/cm³, more preferably 1.30 g/cm³, still more preferably 1.40 g/cm³. On the other hand, the upper limit of the density of the negative active material layer is preferably 1.55 g/cm³, more preferably 1.50 g/cm³. In some aspects, the density of the negative active material layer may be 1.45 g/cm³ or less. When the density of the negative active material layer is within the above range, it is possible to obtain an energy storage device in which the expansion of the negative active material layer which occurs at initial charge and the falling off of the negative active material layer at the folding portion are suppressed.

The porosity of the negative active material layer is preferably 40% or less. By setting the porosity of the negative active material layer to 40% or less, the energy density of the energy storage device can be further increased. The porosity of the negative active material layer is preferably 25% or more. In the energy storage device, by using graphite particles which are solid and have an aspect ratio set to 1 or more and 5 or less as the negative active material, the porosity can be reduced even when the negative active material layer is in the non-pressed or low-pressure pressed state. Thus, it is possible to effectively increase the energy density of the energy storage device while suppressing the falling off of the negative active material layer. Technical value is high also in this respect.

(Intermediate layer)

The intermediate layer is a coating layer on the surface of the negative electrode substrate, and contains conductive particles such as carbon particles to reduce contact resistance between the negative electrode substrate and the negative active material layer. The intermediate layer may cover a part or the entire surface of the negative electrode substrate. The negative electrode substrate may have a region with the intermediate layer stacked and without the negative active material layer stacked. The configuration of the intermediate layer is not particularly limited, and the intermediate layer can be formed of, for example, a composition containing a resin binder and conductive particles.

### [Positive Electrode]

The positive electrode includes a positive electrode substrate and a positive active material layer. The positive active material layer contains a positive active material. The positive active material layer is stacked along at least one surface of the positive electrode substrate directly or with an intermediate layer interposed therebetween.

The positive electrode substrate exhibits conductivity. As the material of the positive substrate, a metal such as aluminum, titanium, tantalum or stainless steel, or an alloy thereof is used. Among these materials, aluminum and aluminum alloys are preferable from the viewpoint of the balance among electric potential resistance, high conductivity, and cost. Examples of the form of the positive substrate include a foil and a vapor deposited film, and a foil is preferable from the viewpoint of cost. More specifically, an aluminum foil is preferable as the positive substrate. Examples of the aluminum or aluminum alloy include A1085 and A3003 prescribed in JIS-H4000 (2014).

The positive active material layer is formed of a so-called positive composite containing a positive active material. The positive composite forming the positive active material layer contains arbitrary components such as a conductive agent, a binder, a thickener, and a filler if necessary.

The positive active material can be appropriately selected from, for example, known positive active materials. As the positive active material for a lithium ion secondary battery, a material capable of storing and releasing lithium ions is usually used. Examples of the positive active material include lithium-transition metal composite oxides having an α-NaFeO₂-type crystal structure, lithium-transition metal composite oxides having a spinel-type crystal structure, polyanion compounds, chalcogenides, and sulfur. Examples of the lithium transition metal composite oxide having an α-NaFeO₂ type crystal structure include Li[LiₓNi₁₋ₓ]O₂ (0≤x<0.5), Li[LiₓNi_{γ}Co_{(1-x-γ)}]O₂ (0≤x<0.5, 0<γ<1), Li[LiₓCo₍₁₋ₓ₎]O₂ (0≤x<0.5), Li[LiₓNi_{γ}Mn_{(1-x-γ)}]O₂ (0≤x<0.5, 0≤γ<1), Li[LiₓNi_{γ}Mn_{β}Co_{(1-x-γ-β)}]O₂ (0≤x<0.5, 0<γ, 0<β, 0.5<γ+β<1), and Li[LiₓNi_{γ}Co_{β}Al_{(1-x-γ-β)}]O₂ (0≤x<0.5, 0<γ, 0<β, 0.5<γ+β<1). Examples of the lithium-transition metal composite oxides having a spinel-type crystal structure include LiₓMn₂O₄ and LiₓNi_{γ}Mn_{(2-γ)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. A part of atoms or polyanions in these materials may be substituted with atoms or anion species composed of other elements. The surfaces of these materials may be coated with other materials. In the positive active material layer, one of these materials may be used singly, or two or more thereof may be used in mixture. In the positive active material layer, one of these compounds may be used singly or two or more of these compounds may be used in mixture. The content of the positive active material in the positive active material layer is not particularly limited, but the lower limit thereof is preferably 50% by mass, more preferably 80% by mass, still more preferably 90% by mass. On the other hand, the upper limit of this content is preferably 99% by mass, more preferably 98% by mass.

The conductive agent is not particularly limited so long as being a conductive material. Such a conductive agent can be selected from the materials exemplified for the negative electrode. When a conductive agent is used, the ratio of the conductive agent to the entire positive active material layer can be about 1.0% by mass or more and 20% by mass or less, and is preferably usually about 2.0% by mass or more and 15 mass % or less (for example, 3.0% by mass or more and 6.0% by mass or less).

Examples of the binder include: thermoplastic resins such as fluororesin (polytetrafluoroethylene (PTFE), polyvinylidene fluoride (PVDF), etc.), polyethylene, polypropylene, and polyimide; elastomers such as ethylene-propylene-diene rubber (EPDM), sulfonated EPDM, styrene-butadiene rubber (SBR), and fluororubber; and polysaccharide polymers. When a binder is used, the ratio of the binder to the entire positive active material layer can be about 0.50% by mass or more and 15% by mass or less, and is preferably usually about 1.0% by mass or more and 10% by mass or less (for example, 1.5 mass % or more and 3.0% by mass or less).

Examples of the thickener mentioned above include polysaccharide polymers such as carboxymethylcellulose (CMC) and methylcellulose. When the thickener has a functional group reactive with lithium, it is preferable to deactivate the functional group by methylation or the like in advance. When a thickener is used, the ratio of the thickener to the entire positive active material layer can be about 8% by mass or less, and is preferably typically about 5.0% by mass or less (for example, 1.0% by mass or less).

The filler can be selected from the materials exemplified for the negative electrode. When a filler is used, the ratio of the filler to the entire positive active material layer can be about 8.0% by mass or less, and is preferably typically about 5.0% by mass or less (for example, 1.0% by mass or less).

The intermediate layer is a coating layer on the surface of the positive electrode substrate, and contains conductive particles such as carbon particles to decrease contact resistance between the positive electrode substrate and the positive active material layer. The intermediate layer may cover a part or the entire surface of the positive electrode substrate. Similarly to the negative electrode, the configuration of the intermediate layer is not particularly limited and can be formed of, for example, a composition containing a resin binder and conductive particles.

### [Separator]

As the separator, for example, a woven fabric, a nonwoven fabric, a porous resin film, and the like are used. Among these, a porous resin film is preferable from the viewpoint of strength, and a nonwoven fabric is preferable from the viewpoint of liquid retaining property of the nonaqueous electrolyte. As a main component of the separator, for example, a polyolefin such as polyethylene or polypropylene is preferable from the viewpoint of strength, and for example, polyimide or aramid is preferable from the viewpoint of resistance to oxidative decomposition. These resins may be composited.

It is to be noted that an inorganic layer may be stacked between the separator and the electrode (usually, the positive electrode). The inorganic layer is a porous layer also called a heat resistant layer or the like. In addition, a separator with an inorganic layer formed on one or both surfaces of the porous resin film can also be used. The inorganic layer is typically composed of inorganic particles and a binder and may contain other components.

### [Nonaqueous Electrolyte]

As the nonaqueous electrolyte, a known nonaqueous electrolyte normally used for a general nonaqueous electrolyte secondary battery (energy storage device) can be used. The nonaqueous electrolyte contains a nonaqueous solvent and an electrolyte salt dissolved in the nonaqueous solvent. The nonaqueous electrolyte may be a solid electrolyte or the like.

As the nonaqueous solvent, it is possible to use a known nonaqueous solvent typically used as a nonaqueous solvent of a general nonaqueous electrolyte for an energy storage device. Examples of the nonaqueous solvent include cyclic carbonate, chain carbonate, ester, ether, amide, sulfone, lactone, and nitrile. Among these, it is preferable to use at least the cyclic carbonate or the chain carbonate, and it is more preferable to use the cyclic carbonate and the chain carbonate in combination. When the cyclic carbonate and the chain carbonate are used in combination, the volume ratio of the cyclic carbonate to the chain carbonate (cyclic carbonate:chain carbonate) is not particularly limited but is preferably from 5:95 to 50:50, for example.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, catechol carbonate, 1-phenylvinylene carbonate, and 1,2-diphenylvinylene carbonate, and among these, EC is preferable.

Examples of the chain carbonate include diethyl carbonate (DEC), dimethyl carbonate (DMC), ethyl methyl carbonate (EMC), and diphenyl carbonate, and among these, EMC is preferable.

As the electrolyte salt, it is possible to use a known electrolyte salt typically used as an electrolyte salt of a general nonaqueous electrolyte for an energy storage device. Examples of the electrolyte salt include a lithium salt, a sodium salt, a potassium salt, a magnesium salt, and an onium salt, and a lithium salt is preferable.

Examples of the lithium salt include inorganic lithium salts such as LiPF₆, LiPO₂F₂, LiBF₄, LiClO₄, and LiN(SO₂F)₂, and lithium salts having a hydrocarbon group in which hydrogen is replaced by fluorine, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these salts, an inorganic lithium salt is preferable, and LiPF₆ is more preferable.

The lower limit of the concentration of the electrolyte salt in the nonaqueous electrolyte is preferably 0.1 mol/dm³, more preferably 0.3 mol/dm³, still more preferably 0.5 mol/dm³, particularly preferably 0.7 mol/dm³. On the other hand, the upper limit is not particularly limited, and is preferably 2.5 mol/dm³, more preferably 2.0 mol/dm³, still more preferably 1.5 mol/dm³.

Other additives may be added to the nonaqueous electrolyte. As the nonaqueous electrolyte, a salt that is melted at normal temperature, an ionic liquid, or the like can also be used.

The energy storage device according to the first embodiment of the present invention is the belt-like body in which the negative electrode is folded in a bellows shape along the longitudinal direction and includes the plurality of folding portions to which large stress is likely to be applied. In the energy storage device, since the graphite particles contained in the negative active material are solid, the density in the graphite particles is uniform, and the graphite particles are nearly spherical due to having an aspect ratio of 1 to 5, so that current concentration is less likely to occur, and uneven expansion of the negative active material layer can thus be prevented. Therefore, in the energy storage device which is the belt-like body in which the negative electrode is folded in a bellows shape along the longitudinal direction, the application effect of this configuration can be more suitably exhibited.

### Second Embodiment

In the energy storage device according to the second embodiment of the present invention, the negative active material contains solid graphite particles, the solid graphite particle has an aspect ratio of 1 or more and 5 or less, and Q2/Q1, which is a ratio of a surface roughness Q2 of the negative electrode substrate in a region without the negative active material layer disposed to a surface roughness Q1 of the negative electrode substrate in a region with the negative active material layer disposed (for example, an exposed region of the negative electrode substrate in a case where the negative electrode has an exposed part of the negative electrode substrate), is 0.90 or more. Configurations other than the above configuration are the same as those of the first embodiment, and thus overlapping description is omitted. When the pressure applied to the negative electrode substrate increases, the Q2/Q1 decreases because the region where the negative active material layer is formed becomes rougher. In other words, in the negative electrode substrate, in the state where no pressure is applied, the surface roughness is almost the same value in the region with the negative active material layer disposed and the region without the negative active material layer disposed (for example, the exposed region of the negative electrode substrate in the case where the negative electrode has the exposed part of the negative electrode substrate). That is, Q2/Q1 becomes close to 1. In the energy storage device, the Q2/Q1 is 0.90 or more, and there is no or little pressure applied to the negative active material layer. Thus, the graphite particles themselves have little residual stress, so that it is possible to suppress uneven expansion of the negative active material layer due to release of the residual stress. Since the graphite particles are solid, the density in the graphite particles is uniform, and the graphite particles are nearly spherical due to having an aspect ratio of 1 to 5, so that current concentration is less likely to occur, and uneven expansion of the negative active material layer can thus be prevented. As described above, since the graphite particles are nearly spherical, orientation of the graphite particles arranged in the active material layer is low, and the directions tend to be random, so that it is possible to suppress uneven expansion of the negative active material layer. Further, since the shape is close to a spherical shape, adjacent graphite particles are hardly caught by each other, and the graphite particles are moderately slid over each other, so that even if the graphite particles expand, they are easily maintained in a state close to closest packing. Thus, in the present invention, it is presumed that even if the graphite particles expand, the particles expand relatively uniformly and moderately slide over each other, so that a negative active material layer having a high packing ratio of the graphite particles is maintained, and as a result, the expansion of the negative active material layer which occurs at initial charge can be suppressed.

The “surface roughness” means a value obtained by measuring a center line roughness Ra of a surface (for a region where the active material layer and other layers are formed, a surface after these layers are removed) of the substrate with a laser microscope in accordance with JIS-B0601 (2013). Specifically, the measured value can be obtained by the following method.

First, in the case where the negative electrode has an exposed part of the negative electrode substrate, the surface roughness of the part is measured in accordance with JIS-B0601 (2013) with the use of a commercially available laser microscope (device name “VK-8510” from KEYENCE CORPORATION), as the surface roughness Q2 of the region without the negative active material layer disposed. In this regard, as measurement conditions, a measurement region (area) is 149 μm×112 μm (16688 μm²), and a measurement pitch is 0.1 μm. Then, the negative active material layer and the other layers are removed from the negative electrode substrate by shaking the negative electrode with the use of an ultrasonic cleaner, and the surface roughness Q1 of the region with the negative active material layer formed is measured similarly to the surface roughness of the exposed part of the negative electrode substrate. It is to be noted that in the case where the negative electrode has no exposed part of the negative electrode substrate (for example, in the case where the entire surface of the negative electrode substrate is covered with the intermediate layer), the surface roughness Q2 of the region without the negative active material layer disposed (for example, the region covered with the intermediate layer, and without the negative active material layer disposed) will be measured by the same method.

The lower limit of the surface roughness ratio (Q2/Q1) is preferably 0.92, and more preferably 0.94, because there is no pressure applied to the negative active material layer or the pressure applied to the negative active material layer is small. On the other hand, the upper limit of the surface roughness ratio (Q2/Q1) is preferably 1.10, and more preferably 1.05.

According to the energy storage device, the falling off of the negative active material layer is suppressed when the negative electrode has a curved folding structure.

### [Method for Manufacturing Energy Storage Device]

A method for manufacturing the energy storage device of the present embodiment can be appropriately selected from known methods. The manufacturing method includes, for example, preparing an electrode assembly, preparing a nonaqueous electrolyte, and housing the electrode assembly and the nonaqueous electrolyte in a case. The preparation of the electrode assembly includes: preparing a positive electrode and a negative electrode; and forming an electrode assembly by stacking the positive electrode and the negative electrode with a separator interposed therebetween. The electrode assembly includes: a negative electrode including a pair of flat portions facing each other and a curved folding portion connecting end portions on one side of the pair of flat portions to each other; and a sheet-like (plate-like) positive electrode disposed between the pair of flat portions of the negative electrode.

In the step of preparing a negative electrode, a negative active material layer containing a negative active material containing solid graphite particles is stacked along at least one surface of a negative electrode substrate by, for example, applying a negative composite to the negative electrode substrate. Specifically, for example, a negative composite is applied to the negative electrode substrate, and dried to stack the negative active material layer. After the drying, before the negative electrode and the positive electrode are stacked, the negative active material layer is not pressed, or the low-pressure pressing is performed.

In the step of housing the nonaqueous electrolyte in a case, the method can be appropriately selected from known methods. For example, when a nonaqueous electrolyte solution is used for the nonaqueous electrolyte, the nonaqueous electrolyte solution may be injected from an inlet formed in the case, followed by sealing the inlet. The details of the respective other elements configuring the energy storage device obtained by the manufacturing method are as described above.

### Other Embodiments

The energy storage device of the present invention is not limited to the embodiments described above, and various changes may be made without departing from the scope of the present invention. For example, to the configuration of an embodiment, the configuration of another embodiment can be added, and a part of the configuration of an embodiment can be replaced by the configuration of another embodiment or a well-known technique. Furthermore, a part of the configuration according to one embodiment can be removed. In addition, a well-known technique can be added to the configuration according to one embodiment.

In FIG. 3, the separator 8 according to the above embodiment is formed by bending one sheet body, but may be formed by joining two sheet bodies.

The separator 8 of the above embodiment is stacked on the positive electrode 14 side, but may be stacked on the negative electrode 15 side. In this case, the separator 8 may have a zigzag shape (zigzag shape having a plurality of folding portions) similarly to the negative electrode 15.

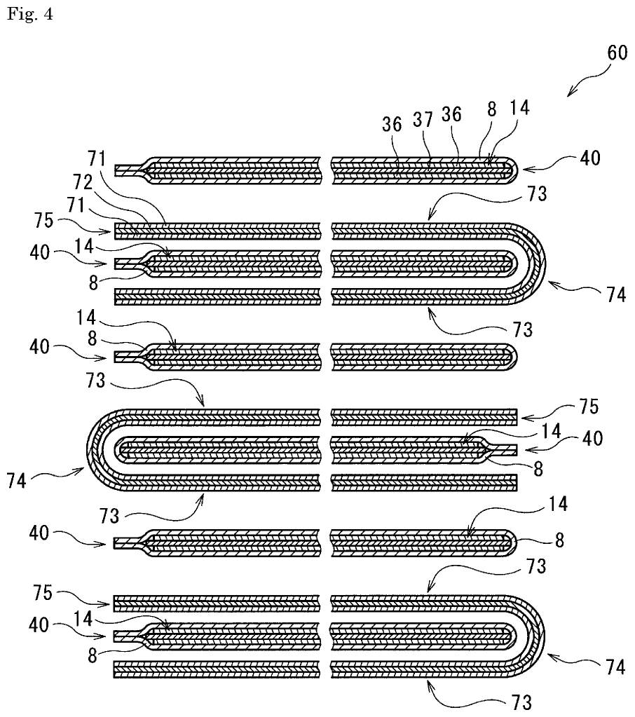

Although the energy storage device 1 of the above embodiment is the belt-like body in which the negative electrode is folded in a bellows shape along the longitudinal direction, the present invention is not limited to this configuration. In the electrode assembly 2, one electrode may have at least one curved folding portion. FIG. 4 is a schematic cross-sectional view illustrating an electrode assembly in another embodiment of the present invention. The energy storage device 60 includes: a sheet-like negative electrode 75 including a pair of flat portions 73 facing each other and a curved folding portion 74 connecting end portions on one side of the pair of flat portions 73 to each other; and a sheet-like (plate-like) positive electrode 14 disposed so as to alternately face the flat portion 73 of the negative electrode 75. In this case, the plurality of positive electrode members 40 are also sandwiched between the curved folding portions 74 of the negative electrode 75. Since the energy storage device includes the negative electrode in which the negative active material layer containing the solid graphite particles is disposed in the non-pressed or low-pressure pressed state, even with such a configuration, the expansion of the negative active material layer which occurs at initial charge is suppressed, stress applied to the composite in the curved folding portion is reduced, and the falling off of the negative active material layer at the folding portion is suppressed. The negative active material layer of the energy storage device can reduce the porosity of the negative active material layer and increase the energy density even in the non-pressed or low-pressure pressed state. In the embodiment illustrated in FIG. 4, the folding portions 74 are alternately arranged with the direction reversed, but may be arranged in the same direction.

In the above embodiment, the energy storage device is a nonaqueous electrolyte secondary battery, but other energy storage devices may be used. Examples of the other energy storage devices include capacitors (electric double-layer capacitor, lithium ion capacitor). Examples of the nonaqueous electrolyte secondary battery include a lithium ion nonaqueous electrolyte secondary battery.

The present invention can also be realized as an energy storage apparatus including a plurality of the energy storage devices. An assembled battery can be constituted using one or a plurality of energy storage devices (cells) of the present invention, and an energy storage apparatus can be constituted using the assembled battery. The energy storage apparatus can be used as a power source for an automobile, such as an electric vehicle (EV), a hybrid vehicle (HEV), or a plug-in hybrid vehicle (PHEV). In addition, the energy storage apparatus can be used for various power source apparatuses such engine starting power source apparatuses, auxiliary power source apparatuses, and uninterruptible power systems (UPSs).

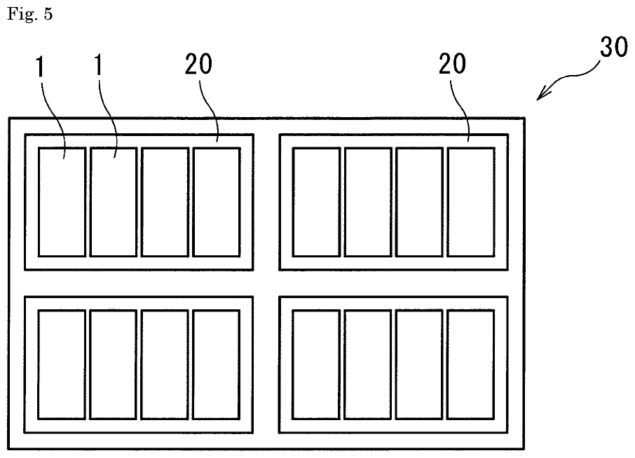

FIG. 5 illustrates an example of an energy storage apparatus 30 formed by assembling energy storage units 20 in each of which two or more electrically connected energy storage devices 1 are assembled. The energy storage apparatus 30 may include a busbar (not illustrated) for electrically connecting two or more energy storage devices 1 and a busbar (not illustrated) for electrically connecting two or more energy storage units 20. The energy storage unit 20 or the energy storage apparatus 30 may include a state monitor (not illustrated) for monitoring the state of one or more energy storage devices.

### EXAMPLES

Hereinafter, the present invention will be described in more detail with reference to examples, but the present invention is not limited to the following examples.

### Preparation of Negative Electrodes of Examples 1 and 2 and Comparative Examples 1 to 6

Prepared was a negative composite paste containing a negative active material having the composition illustrated in Table 1, a styrene-butadiene rubber as a binder, and a carboxymethyl cellulose as a thickener with water as a dispersion medium. Amass ratio of the negative active material, the binder, and the thickener was 97.4:2.0:0.6. The negative composite paste was applied onto both surfaces of a negative electrode substrate (surface roughness: 0.74 μm) formed of an 8 μm-thick copper foil and dried to form a negative active material layer, and negative electrodes of Examples 1 and 2 and Comparative Examples 1 to 6 were obtained. Physical property values of the negative active material measured by the following method and the presence or absence of a pressing step are illustrated in Table 1. The coating amount of the negative active material layer (obtained by evaporating the dispersion medium from the negative composite paste) per unit area of one surface after drying was set to 1.55 g/100 cm². Pressing was performed using a roll press so that in the negative electrode of Example 2, the pressure (linear pressure) was less than 10 kgf/mm and in the negative electrodes of Comparative Examples 1, 2, 4, and 6, the pressure (linear pressure) was 40 kgf/mm or more. In Examples 1 and 2, massive solid graphite having a BET specific surface area of 3.9 m²/g was used.

### Preparation of Energy Storage Devices of Examples 1 and 2 and Comparative Examples 1 to 6

An energy storage device including a negative electrode having a curved folding portion was produced by the following procedure.

An electrode assembly was prepared using the negative electrodes of Examples 1 and 2 and Comparative Examples 1 to 6 illustrated in Table 1, a positive electrode described later, and a polyethylene separator having a thickness of 20 μm. The positive electrode contains LiNi_{1/3}Co_{1/3}Mn_{1/3}O₂ as a positive active material, polyvinylidene fluoride (PVDF) as a binder, and acetylene black as a conductive agent, and a positive composite paste was prepared using n-methyl-2-pyrrolidone (NMP) as a dispersion medium. A mass ratio of the positive active material, the binder and the conductive agent was 94:3:3. The positive composite paste was applied to both surfaces of a 12 μm-thick positive electrode substrate formed of an aluminum foil and dried to form a positive active material layer. The coating amount of the positive composite (obtained by evaporating the dispersion medium from the positive composite paste) per unit area of one surface after drying was set to 2.1 g/100 cm². Thereafter, pressing was performed using a roll press. The positive electrode, the negative electrode, and the separator were stacked to prepare the electrode assembly illustrated in FIGS. 2 and 3. Next, a nonaqueous electrolyte solution was prepared by mixing LiPF₆ as an electrolyte salt so as to have a content of 1.2 mol/km³ in a nonaqueous solvent obtained by mixing EC, EMC, and DMC at a volume ratio of 30:35:35.

Thereafter, the non-stacked portion of the positive electrode substrate and the non-stacked portion of the negative electrode substrate were respectively welded to a positive current collector and a negative current collector, and enclosed in a case. Next, after the case was welded to a lid plate, the nonaqueous electrolyte was injected into the case, and a case opening was sealed. In this way, energy storage devices of Examples 1 and 2 and Comparative Examples 1 to 6 were obtained.

[Evaluation]

### (Density of Negative Active Material Layer)

The density of the negative active material layer can be calculated from the following formula, where W (g/100 cm²) is a coating amount of the negative active material layer and T (cm) is a thickness of the negative active material layer before charge-discharge as described later.

Density of negative active material layer (g/cm³)=W/(T×100)

### (Ratio of Surface Roughness of Negative Electrode Substrate)

The surface roughness Q1 of the region with the negative active material layer formed and the surface roughness Q2 of the exposed part of the negative electrode substrate of the negative electrode were measured using a laser microscope as described above. Thereafter, the surface roughness ratio (Q2/Q1) of the negative electrode substrate was calculated using the measured Q1 and Q2. Here, when the surface roughness Q1 of the region with the negative active material layer formed was measured, the negative active material layer was removed by shaking while being immersed in water for three minutes and in ethanol for one minute using a desktop ultrasonic cleaner 2510J-DTH from Branson Ultrasonics, Emerson Japan, Ltd.

### (Measurement of Thickness of Negative Active Material Layer Before Charge-Discharge)

Ten samples of the negative electrode before preparation of the energy storage device, each of which had an area of 2 cm×1 cm, were prepared as measurement samples, and the thickness of each of the negative electrodes was measured using a high precision Digimatic Micrometer manufactured by Mitutoyo Corporation. For each negative electrode, the thickness of the negative electrode was measured at five positions, and from the average value thereof, the thickness of the negative electrode substrate (8 μm) was subtracted to measure the thickness of the negative active material layer of one negative electrode before charge-discharge. The average value of the thicknesses of the negative active material layer before charge-discharge, which had been measured for the ten negative electrodes, was calculated, and defined as the thickness of the negative active material layer before charge-discharge.

### (Measurement of Thickness of Negative Active Material Layer in Full Charge)

The energy storage devices of examples and comparative examples before charge-discharge were initially charged at constant current constant voltage (CCCV) charge with a current density of 2 mA/cm², an end-of-charge current density of 0.04 mA/cm², and an upper limit voltage of 4.25 V, and to be in a full charge state. Then, the thickness of the negative active material layer in the full charge state was measured. In measurement of the thickness of the negative active material layer in full charge, the thickness of the negative active material layer in full charge was measured similarly to the measurement of the thickness of the negative active material layer before charge-discharge except that the energy storage device in full charge was disassembled in a glove box filled with argon with a dew point value of −60° C. or lower, and the negative electrode washed with DMC was used as a measurement sample.

### (Measurement of Amount of Expansion of Negative Active Material at Initial Charge)

The amount of expansion of the negative active material at initial charge was calculated by subtracting the “thickness of the negative active material layer before charge-discharge” from the “thickness of the negative active material layer in full charge” calculated by the above-described method.

### (Measurement of Porosity of Negative Active Material Layer)

The porosity of the negative active material layer is a calculated value calculated from the mass of constituent components contained in the negative active material layer, the true density, and the thickness of the negative active material layer. Specifically, the porosity is calculated by the following formula.

Porosity (%) of negative active material layer={1−(density of negative active material layer/true density of negative active material layer)}×100

Here, the “density of the negative active material layer” (g/cm³) is calculated from the coating amount W of the negative active material layer and the thickness T of the negative active material layer before charge-discharge as described above.

The “true density of the negative active material layer” (g/cm³) is calculated from the value of the true density of each constituent component contained in the negative active material layer and the mass of each constituent component. Specifically, the true density of the negative active material layer is calculated from the following formula, where D1 (g/cm³) is the true density of the negative active material, D2 (g/cm³) is the true density of the binder, D3 (g/cm³) is the true density of the thickener, W1 (g) is the mass of the negative active material contained in 1 g of the negative active material layer, W2 (g) is the mass of the binder contained in 1 g of the negative active material layer, and W3 (g) is the mass of the thickener contained in 1 g of the negative active material layer.

True density (g/cm³) of negative active material layer=1/{(W1/D1)+(W2/D2)+(W3/D3)}

### (Evaluation of Falling Off of Composite at Folding Portion of Negative Electrode)

The energy storage device after the initial charge was discharged at a constant current (CC) with a current density of 2 mA/cm² and a lower limit voltage of 2.75 V to be in a discharged state. The energy storage device in the discharged state was disassembled and visually observed, and the presence or absence of the falling off of the negative active material layer at the folding portion of the negative electrode was determined.

The following Table 1 illustrates the evaluation results of the area ratio T of the negative active material particles excluding voids in the particles of each energy storage device, the aspect ratio of the graphite particles, the density of the negative active material layer, the ratio Q2/Q1 of the surface roughness of the negative electrode substrate, the thickness of the negative active material layer before charge-discharge, the thickness of the negative active material layer in full charge, the amount of expansion of the negative active material at initial charge, the porosity of the negative active material layer, and the falling off of the negative active material layer at the folding portion of the negative electrode. The area ratio T and the aspect ratio of the graphite particles used were calculated by the above-described method.

TABLE 1

| | | | | | | Evaluation |
|---|---|---|---|---|---|---|
| | | | Physical properties of | | | Negative electrode flat portion |
| | | | negative active material | | Presence or absence | Negative |
| | Negative active material | | Area ratio T | Graphite | of step of pressing | active material |
| Negative | | Content rate | excluding void | particle | negative active | layer density |
| electrode | Composition | [%] | [%] | aspect ratio | material layer | [g/cm3] |
| Example 1 | Solid graphite | 100.0 | 99.1 | 2.7 | Absence | 1.42 |
| | particle | | | | | |
| Example 2 | Solid graphite | 100.0 | 99.1 | 2.7 | Low-pressure | 1.49 |
| | particle | | | | press | |
| Comparative | Hollow graphite | 100.0 | 88.8 | 1.5 | Presence | 1.57 |
| Example 1 | particle | | | | | |
| Comparative | Hollow graphite | 100.0 | 88.8 | 1.5 | Presence | 1.42 |
| Example 2 | particle | | | | | |
| Comparative | Hollow graphite | 100.0 | 88.8 | 1.5 | Absence | 0.98 |
| Example 3 | particle | | | | | |
| Comparative | Solid graphite | 100.0 | 99.1 | 2.7 | Presence | 1.57 |
| Example 4 | particle | | | | | |
| Comparative | Solid graphite | 100.0 | 98.1 | 8.6 | Absence | 0.94 |
| Example 5 | particle | | | | | |
| Comparative | Solid graphite | 100.0 | 98.1 | 8.6 | Presence | 1.42 |
| Example 6 | particle | | | | | |

| | Evaluation | | | | | |
|---|---|---|---|---|---|---|
| | Negative electrode flat portion | | | | | |
| | Ratio of | | | | | |
| | surface | Thickness of | | Amount of | | Negative |
| | roughness of | negative active | Thickness of | expansion of | | electrode |
| | negative | material layer | negative active | negative active | Porosity of | folding portion |
| | electrode | before charge- | material layer | material layer at | negative active | Falling off of |
| Negative | substrate | discharge | in full charge | initial charge | material layer | active material |
| electrode | Q2/Q1 | [μm] | [μm] | [μm] | [%] | layer |
| Example 1 | 0.97 | 109 | 118 | 9 | 34.0 | Absence |
| Example 2 | 0.95 | 104 | 115 | 10 | 31.0 | Absence |
| Comparative | 0.75 | 109 | 126 | 26 | 27.0 | Presence |
| Example 1 | | | | | | |
| Comparative | 0.82 | 109 | 131 | 22 | 34.0 | Presence |
| Example 2 | | | | | | |
| Comparative | 0.97 | 109 | 172 | 13 | 54.8 | Absence |
| Example 3 | | | | | | |
| Comparative | 0.75 | 109 | 119 | 19 | 27.0 | Presence |
| Example 4 | | | | | | |
| Comparative | 0.97 | 109 | 178 | 13 | 56.3 | Absence |
| Example 5 | | | | | | |
| Comparative | 0.75 | 109 | 129 | 20 | 34.0 | Presence |
| Example 6 | | | | | | |

As illustrated in Table 1, in Examples 1 to 2 including: a negative electrode including a pair of flat portions facing each other and a curved folding portion connecting end portions on one side of the pair of flat portions to each other; and a positive electrode disposed between the pair of flat portions of the negative electrode a positive electrode disposed between the pair of flat portions of the negative electrode, in which the negative active material layer was disposed in the non-pressed or low-pressure pressed state, the solid graphite particle that was the negative active material had an aspect ratio of 1 or more and 5 or less, and the ratio Q2/Q1 of the surface roughness of the negative electrode substrate was 0.90 or more, the amount of expansion of the negative active material layer at initial charge was small, and the falling off of the negative active material layer at the folding portion was suppressed.

On the other hand, in Comparative Examples 1, 2, 4, and 6 in which the negative active material layer was disposed in the pressed state and the ratio Q2/Q1 of the surface roughness of the negative electrode substrate was less than 0.90, the amount of expansion of the negative active material at initial charge was significantly increased as compared with Examples 1 and 2. Even when the negative active material layer was disposed in the non-pressed or low-pressure pressed state, and the ratio Q2/Q1 of the surface roughness of the negative electrode substrate was 0.90 or more, in Comparative Example 3 in which hollow graphite particles were used as the negative active material and Comparative Example 5 in which the aspect ratio was more than 5, the amount of expansion of the negative active material at initial charge of the negative active material layer was increased as compared with Examples 1 and 2.

In addition, with respect to the porosity of the negative active material layer, comparison between Example 1 and Comparative Examples 3 and 5 in which the negative active material layer was disposed in the non-pressed state showed that the porosity was small in Example 1 although the negative active material layer was disposed in the non-pressed state, and the packing ratio of the negative active material could be increased.

As described above, it was shown that in the energy storage device, when the negative electrode has the curved folding structure, the expansion of the negative active material layer which occurs at initial charge and the falling off of the negative active material layer at the folding portion are suppressed.

### INDUSTRIAL APPLICABILITY

The present invention is suitably used as an energy storage device including a nonaqueous electrolyte secondary battery used as a power source for electronic equipment such as personal computers and communication terminals, automobiles, and the like.

### DESCRIPTION OF REFERENCE SIGNS

1: energy storage device
2, 60: electrode assembly
3: case
4: positive electrode terminal
5: negative electrode terminal
6: lid
8: separator
14: positive electrode
15, 75: negative electrode
20: energy storage unit
30: energy storage apparatus
31, 71: negative active material layer
32, 72: negative electrode substrate
33, 73: flat portion
34, 74: folding portion
36: positive active material layer
37: positive electrode substrate
40: positive electrode member
42: positive electrode tab
52: negative electrode tab

1. An energy storage device comprising:
a negative electrode including a pair of flat portions facing each other and a curved folding portion connecting end portions on one side of the pair of flat portions to each other; and
a positive electrode disposed between the pair of flat portions of the negative electrode,
wherein the negative electrode includes a negative electrode substrate and a negative active material layer stacked on a surface of the negative electrode substrate directly or indirectly in a non-pressed or low-pressure pressed state,
the negative active material layer contains a negative active material,
the negative active material contains a solid graphite particle, and
the solid graphite particle has an aspect ratio of 1 or more and 5 or less.

2. An energy storage device comprising:
a negative electrode including a pair of flat portions facing each other and a curved folding portion connecting end portions on one side of the pair of flat portions to each other; and
a positive electrode disposed between the pair of flat portions of the negative electrode,
wherein the negative electrode includes a negative electrode substrate and a negative active material layer directly or indirectly stacked on a surface of the negative electrode substrate,
the negative active material layer contains a negative active material,
the negative active material contains a solid graphite particle,
the solid graphite particle has an aspect ratio of 1 or more and 5 or less, and
a ratio Q2/Q1 of a surface roughness Q2 of the negative electrode substrate in a region without the negative active material layer disposed to a surface roughness Q1 of the negative electrode substrate in a region with the negative active material layer disposed is 0.90 or more.

3. The energy storage device according to claim 1, wherein the negative electrode is a belt-like body folded in a bellows shape along a longitudinal direction of the negative electrode.

4. The energy storage device according to claim 1, wherein the positive electrode includes a plurality of positive electrodes,
each positive electrode of the plurality of the positive electrodes is a plate-like positive electrode.

5. The energy storage device according to claim 4, wherein the plate-like positive electrode includes a positive electrode substrate and a positive active material layer,
the positive electrode substrate includes a principal surface facing one of the pair of the flat portions of the negative electrode,
the positive active material layer is directly or indirectly stacked on the principal surface of the positive electrode substrate,
the negative active material layer of the curved folding portion does not face the positive active material layer directly or indirectly stacked on the principal surface of the positive electrode substrate.

6. The energy storage device according to claim 2, wherein the negative electrode is a belt-like body folded in a bellows shape along a longitudinal direction of the negative electrode.

7. The energy storage device according to claim 2, wherein the positive electrode includes a plurality of positive electrodes,
each positive electrode of the plurality of the positive electrodes is a plate-like positive electrode.

8. The energy storage device according to claim 7, wherein the plate-like positive electrode includes a positive electrode substrate and a positive active material layer,
the positive electrode substrate includes a principal surface facing one of the pair of the flat portions of the negative electrode,
the positive active material layer is directly or indirectly stacked on the principal surface of the positive electrode substrate,
the negative active material layer of the curved folding portion does not face the positive active material layer directly or indirectly stacked on the principal surface of the positive electrode substrate.
